(19) United States
(12) Patent Application Publication
(10) Pub. No.: US 2007/0195683 A1
(43) Pub. Date: Aug. 23, 2007

(54) Cd or dvd with a printable layer and removable borders.

(76) Inventors: Timothy Edward Milverton, London (GB); Peter Gowrie-Smith, London (GB)

Correspondence Address: ABELMAN, FRAYNE & SCHWAB, 666 THIRD AVENUE, 10TH FLOOR, NEW YORK, NY, 10017, US

(21) Appl. No.: 10/574,951

(22) PCT Filed: Oct. 25, 2004
(86) PCT No.: PCT/AU04/01466

§ 371 Date: Dec. 13, 2006

(30) Foreign Application Priority Data
Oct. 23, 2003 (AU) 2003905847

(51) Int. Cl. G11B 7/24

(52) U.S. Cl. 369/275.1

(57) ABSTRACT

A CD or DVD has a blank printable layer (11) on its upper surface, the printable layer having an inner periphery (12), an outer periphery (14), a removable inner border (13) adjacent the inner periphery (12) and a removable outer border (15) adjacent the outer periphery (14). In use, the desired material is printed onto the printable layer (11) within the confines of the inner and outer borders (13 & 15) with the usual result that some of the material is unintentionally printed off-centre onto the inner and outer borders (13 and 15). The borders (13 and 15) can then be removed so that the remaining printed material appears as a symmetrical printed label. If, however, the material is printed symmetrically, the borders (13 and 15) do not need to be removed.

### TECHNICAL FIELD

This invention relates to labels and more particularly to a method of printing labels onto the upper surface of a CD or DVD and to a method of constructing a CD or DVD to allow for such labelling.

### BACKGROUND ART

Consumers often wish to label CD or DVD's but printing errors are a problem and only expensive printers can label directly onto a CD or DVD and even these expensive printers have some problems centering correctly. Misprinting will occur and give rise to border errors that are unattractive.

Hitherto, consumers often cut the borders of misprinted photos but this is not possible with CD's or DVD's and thus there is a need for a simple and effective solution to the problem of misprinting a label onto a CD or DVD surface.

### DISCLOSURE OF INVENTION

According to one aspect of the invention there is provided a CD or DVD having a blank printable layer on its upper surface, the printable layer having an inner periphery,.an outer periphery, a removable inner border adjacent the inner periphery and a removable outer border adjacent the outer periphery.

In use, the desired material is printed onto the printable layer within the confines of the inner and outer borders with the usual result that the material is unintentionally printed off-centre onto the inner and outer borders. The borders can then removed so that the remaining printed material appears as a symmetrical printed label. If, however, the material is printed symmetrically, then the borders do not need to be removed and can remain intact.

### BRIEF DESCRIPTION OF THE DRAWINGS

FIG. 1 is a top plan of a CD having a printable layer thereon according to one embodiment of the invention and upon which material has been asymmetrically printed,

FIG. 2 is an enlarged view of the outer periphery of the CD shown in FIG. 1,

FIG. 3 is a partial side elevational view of the central portion of the CD shown in FIG. 1, showing the removal tab,

FIG. 4 is a partial side elevational view of the outer portion of the CD shown in FIG. 1 showing the removal tab,

FIG. 5 is a top plan view of the CD shown in FIG. 1 with both borders removed, and

FIG. 6 is an exploded view of a CD having removable membranes according to a second embodiment of the invention,

FIG. 7 is a side view of the CD shown in FIG. 6,

FIG. 8 is a top plan view of the CD shown in FIG. 6,

FIG. 9 is an enlarged partial side view of portion A of the CD shown in FIG. 7,

FIG. 10 is an enlarged partial top plan view of the portion B of the CD shown in FIG. 8, and

FIG. 11 is an enlarged partial top plan view of the portion C of the CD shown in FIG. 8.

### MODES FOR CARRYING OUT THE INVENTION

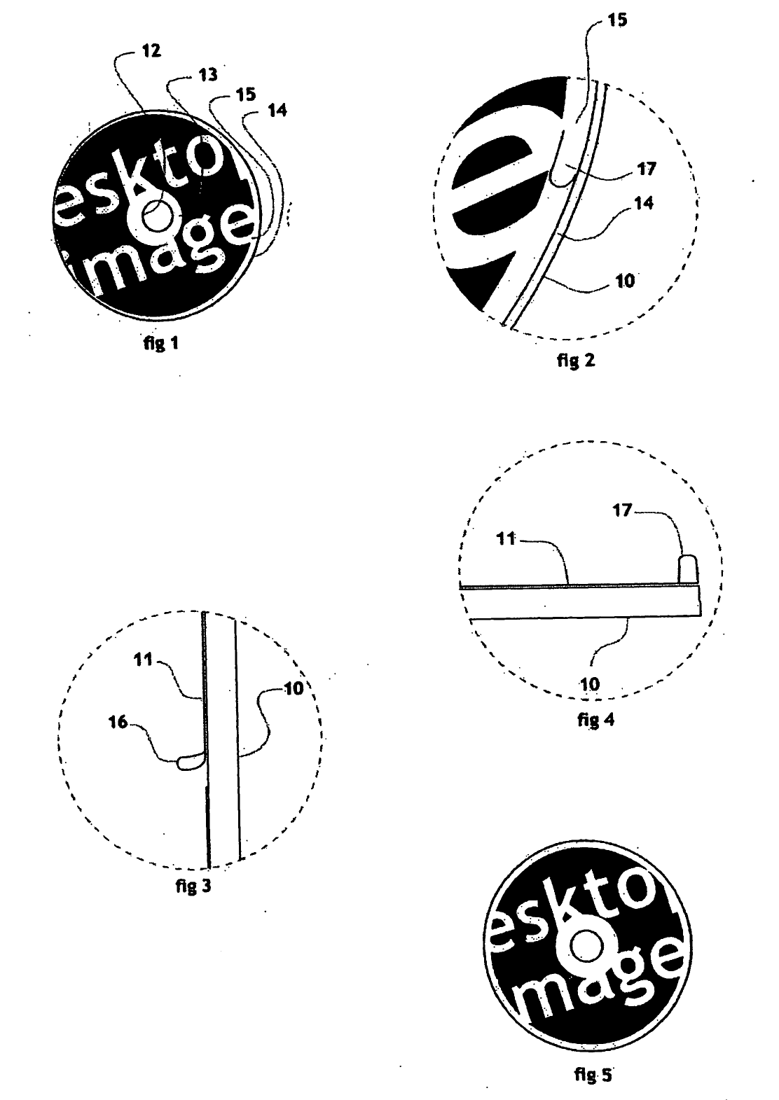

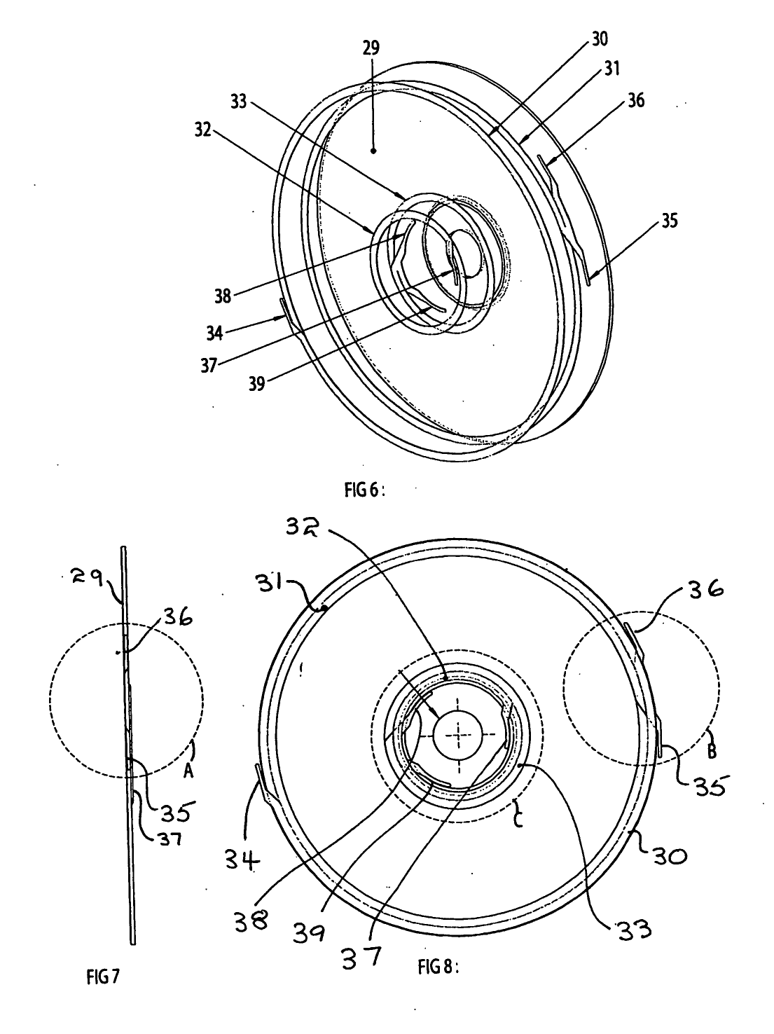

The CD or DVD 10 shown in FIGS. 1 to 5 has a printable layer 11 on its upper surface. The printable layer 11 has an inner periphery 12 and an outer periphery 14. Adjacent the inner periphery 12 there is a removable inner border 13 and adjacent the outer periphery 14 there is a removable adjacent outer border 15. The inner border 13 has a tab 16 and the outer border 15 has a tab 17. The tabs 16 and 17 allow for easy removal of the borders 13 and 15.

The borders 13 and 15 may be part of a large annulus that itself is printable and a circumferential score line or perforation may be provided between the borders and the main portion of the printable layer 11 to establish a mechanical weakness allowing for a guided tear-off of the borders. Alternatively, the inner and outer borders, 13 and 15 may consist separately of two annuli, with the printable coating covering the CD 10 and the borders 13 and 15 to form the printable layer.

The intended placement of the printable layer 11 is upon the upper surface of a CD or DVD post conventional construction. Conventional construction consists of a polycarbonate disc upon which is layered the necessary chemicals to allow for recording of data, followed by a reflective layer, usually aluminium or gold, followed by a protective lacquer layer.

The borders 13 and 15 are adhered to the upper surface of the CD or DVD 10 in any convenient way by any convenient adhesive which will allow for the easy removal of the inner and outer borders leaving the main portion of the printable layer intact.

The tabs 16 and 17 may be detachable from the borders so that the tabs may be removed if the borders are to remain.

After the required material has been printed onto the printable layer 11 as shown in FIG. 1, the inner and outer borders 13 and 15 are removed by pulling the tabs 16 and 17 respectively. When the borders are removed, the remaining printed material on the printable layer 11 appears as a symmetrical printed label as shown in FIG. 5.

An alternative to the above concept is the introduction of a second border, the idea being the first border is always removed, the second border being “selectively” removable, that is, if after removal of the first border, the second can be left if the image appears centred, otherwise, it can be removed. More than two borders may be provided if needed.

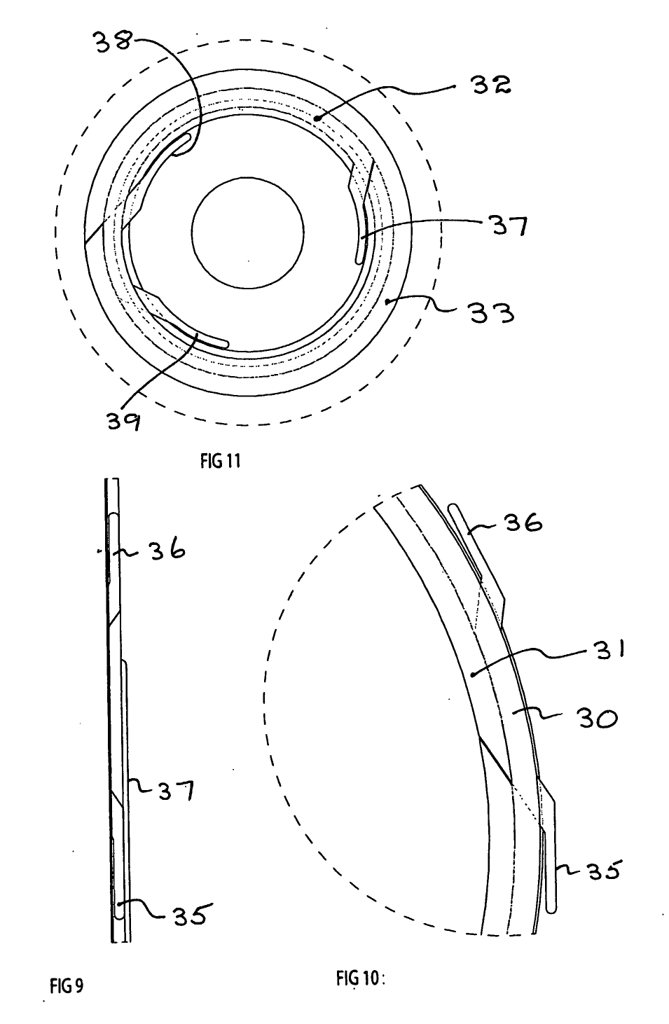

This second embodiment of the invention is shown in FIGS. 6 to 11. The CD or DVD 29 has four separate annular membranes 30, 31, 32 and 33 on its upper surface which act as removable borders. Removable border 31 lies beneath but within removable border 30 and removable border 33 lies beneath but around removable border 32. Removable border 30 which has a tab 34 and removable border 31 which has tabs 35 and 36 lie adjacent one another (in plan—see FIG. 10) on the outer periphery of the CD 29. Removable border 32 which has a tab 37 and removable border 33 which has tabs 38 and 39 are located adjacent one another (in plan—see FIG. 11) in the central portion of the CD 29.

Tabs 34 and 37 allow for easy removal of the first layer of removable borders, namely removable borders 30 and 32. As border 30 and border 32 are removed, the tabs for border 31 and border 33 are revealed, which allow for easy removal of border 31 and border 33 via tab 35 and tab 38 respectively.

The removable borders 31 and 33 are placed upon the upper surface of a CD or DVD 29 during conventional construction. These borders 31 and 33 are placed upon the lacquer layer, beneath any layer that is applied that allows for the absorption of ink-jet printing dye (“printable layer”).

Removable borders 30 and 32 are adhered to the upper surface either before or after the printable layer is applied in any convenient way by any convenient adhesive which will allow for easy removal while leaving removable borders 31 and 33 intact.

Tab 36 and tab 39 allow for the easy removal of tab 35 and tab 38 respectively if the inner borders 31 and 33 are to remain.

After the required material has been printed onto the CD or DVD 29, border 30 and border 32 are removed by pulling tab 34 and tab 37 respectively. When the borders 30 and 32 are removed, border 31 and border 33 allow for refinement of the centring of the remaining printed material by either being removed, via tab 35 and tab 38 respectively, or by remaining by removing tab 35 and tab 38 via tab 36 and tab 39 respectively.

The use of a CD or DVD with the removable borders selected as appropriate is a solution to current label printing errors.

The removable borders have a secondary benefit that users can more confidently target the placement of the printed material within the edges of the CD or DVD thus removing the need for overprinting beyond the edge simply to achieve a centred print. As a result, misprinted ink ends up on the removable borders not on the substrate or the hardware of the device that is holding the CD or DVD—for example the printer.

Various modifications may be made in details of design and application of the invention without departing from the scope and ambit of the invention.

1. A CD or DVD having a data layer, a reflective layer, a lacquer or protective layer and a printable layer on its upper surface, the printable layer having an inner periphery and an outer periphery, a removable inner border adjacent the inner periphery and a removable outer border adjacent the outer periphery, the inner and outer borders being selectively removable from the CD or DVD.

2. A CD or DVD according to claim 1 wherein the inner and outer borders are first inner and outer borders and there is provided a second inner border which lies beneath and outside of the first inner border and a second outer border which lies beneath and within the first outer border.

3. A CD or DVD according to claim 2 wherein the second inner and outer removable borders are placed on the upper surface of the CD or DVD.

4. A CD or DVD according to claim 3 wherein the second inner and outer removable borders are placed upon the lacquer layer of the CD or DVD beneath the printable layer.

5. A CD or DVD according to claim 2 wherein the first inner and outer removable borders are placed on the CD or DVD either before or after the printable layer.

6. A CD or DVD according to claim 2 wherein the first inner and outer removable borders have a tab by means of which the borders may be removed from the CD or DVD.

7. A CD or DVD according to claim 2 wherein the second inner and outer removable borders have a tab by means of which the borders may be removed from the CD or DVD.

8. A CD or DVD according to claim 7 wherein the second inner and outer removable borders have a second tab by means of which the first tab may be removed from the CD or DVD.

9. A CD or DVD according to claim 1 wherein the removable borders are formed on a membrane beneath the printable layer.

10. A CD or DVD according to claim 1 wherein the removable borders are formed on a membrane that incorporates the printable layer.

11. A CD or DVD according to claim 1 wherein the removable borders are formed on separate annuli which underlie the inner and outer peripheries of the printable layer.

12. A CD or DVD according to claim 6 wherein each tab is removable from its border.

13. A CD or DVD according to claim 7 wherein each tab is removable from its border.
